(19) United States
(12) Patent Application Publication
(10) Pub. No.: US 2005/0164850 A1
(43) Pub. Date: Jul. 28, 2005

(54) Mobile exercise machine

(76) Inventor: Todd Leibowitz, (US)

Correspondence Address: NEAL, GERBER, & EISENBERG, SUITE 2200, 2 NORTH LASALLE STREET, CHICAGO, IL, 60602, US

(21) Appl. No.: 10/755,914

(22) Filed: Jan. 13, 2004

(51) Int. Cl. A63B 21/00; A63B 22/00; A61H 3/00; A63B 71/00

(52) U.S. Cl. 482/93; 482/74; 482/66

(57) ABSTRACT

A mobile exercise machine that is pulled by the user. Once in use, the user jumps and is temporarily suspended in mid-air by the machine. The user can return to the ground by either shifting his or her weight slightly forward or by engaging a set of hand brakes that actuate a braking mechanism attached to each wheel.

### BACKGROUND OF THE INVENTION

The present invention relates to exercise devices, and in particular to a mobile exercise device that is pulled by a user. The invention is capable of temporarily suspending the user, requiring the user to support himself only by his upper body strength. While there are common exercises and exercise machines that increase a user's running stamina and strength and common exercises and exercise machines that increase a user's upper body strength, none have combined the two activities into a single, mobile unit.

### SUMMARY OF THE INVENTION

The invention disclosed herein relates to a mobile exercise machine. In the preferred embodiment, the user may walk or run while pulling the exercise machine. At any time, the user may jump and be lifted off of the ground by the machine. While suspended, the user rests his torso on a bracing structure and further supports himself using hand grips. When the user wishes to cease his suspension, he either leans slightly forward over the bracing structure, or applies the hand brakes. Either action will return the user to the ground, in which position he can again begin pulling the machine.

### BRIEF DESCRIPTION OF THE DRAWINGS

FIG. 1 is a side view of the mobile exercise machine.

FIG. 2 is a top plan view of the mobile exercise machine.

### DETAILED DESCRIPTION OF THE DRAWINGS

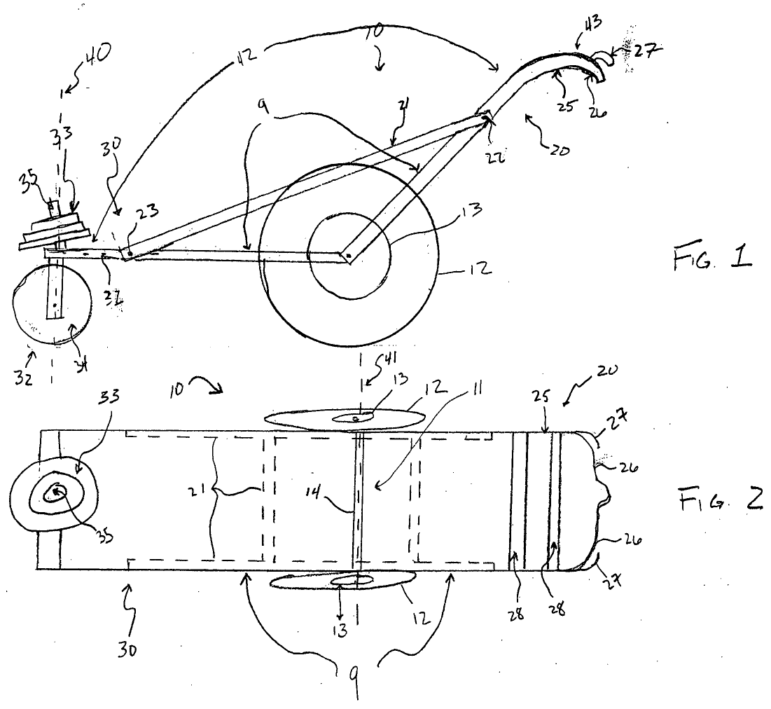

This invention is shown in FIGS. 1 and 2, which depict the preferred embodiment of the invention, but it will be understood that the present invention is in no way limited to this embodiment. Identical structures are given identical numerals in each figure.

As shown in FIG. 1, the preferred embodiment of exercise machine 10 includes a frame 9, which is formed by metal tubing, although equivalent materials can be used. Frame 9 is mounted on wheel assembly 11 which consists of a pair of wheels 12 mounted on an axle 14. Preferably, each wheel 12 is mounted on axle 14 in a manner such that it can rotate independently from the other. In order to create more stability when the user is suspended, wheels 12 are generally slightly angled, such that the distance between the tops of wheels 12 is shorter than the distance between the bottom of wheels 12 as shown in FIG. 1. Frame 9 of machine 10 is mounted on and rotatable about wheel assembly 11. A braking assembly 13 is connected to each of wheels 12. Each braking assembly 13 is shown as a disc brake, although equivalent braking systems can be used to accomplish braking.

Frame 9 has a trailing end 30 which extends rearward from wheel assembly 11. Trailing end 30 has several rear affixation points 31 located there along. These points 31 are a series of holes drilled through the tubing of trailing end 30 and equally spaced. Landing assembly 32, which comprises a pair of wheels 34 and is rotatable about a vertical axis 40 as shown in FIG. 1, is connected to trailing end 30. While landing assembly 32 is rotatable about vertical axis 40, it is generally biased such that, when the user is running and trailing end 30 is suspended, the wheels 34 run parallel with wheels 12. Counterweights 33 are also supported on a rod 35 extending upward from trailing end 30.

Frame 9 has a leading end 20, which extends forward from wheel assembly 11. Leading end 20 is connected to trailing end 30 by a tying rod 21. The forward end of tying rod 21 is connected to leading end 20 at, and is rotatable about, forward affixation point 22. The rearward end of tying rod 21 is connected to trailing end 30 at any one of rear affixation points 31 by means of a quick release pin 23 (not shown in detail). Quick release pin 23 is preferably of the kind generally used on bicycle seats and wheels. Independent of trailing end 30, leading end 20 is rotatable at wheel assembly 11 about Z-axis 41 which runs parallel to axle 14. The amount of counter weights 33 needed to achieve the short periods of suspension is directly related to the weight of the user and the angle 42 between leading end 20 and the trailing end 30. Thus, assuming a constant weight of the user, the more acute angle 42, the less counterweights 33 needed to attain the suspension. Conversely, the more obtuse angle 42, the more counterweights 33 needed. Connecting tying rod 21 to trailing end 30 at the most forward of rear affixation points 31 will relate to the most obtuse angle 42 between leading end 20 and trailing end 30. Conversely, connecting tying rod 21 to trailing end 30 at the most rearward of rear affixation points 31 will relate to the most acute angle 42 between leading end 20 and trailing end 30.

Harness structure 25 is connected to leading end 20. In the preferred embodiment, harness structure 25 is formed of metal tubing and is an ovate shape, wide enough to accommodate an average user. Harness structure 25 may be a separate structure attached to leading end 20 or a continuation of leading end 20. As shown in FIG. 1, the bracing structure has a slightly bent portion 43 such that when landing assembly 32 is in contact with the ground, bent portion 43 is generally parallel with the ground. This way, when the user is suspended, he may more comfortably grasp grip portions 26 to steady and support his weight. Bracing structures 28 are attached to, but moveable on harness structure 25. Only one bracing structure is necessary for operation of the machine, but two may be used in tandem. Preferably, bracing structures 28 are a slightly elastic material such as a large rubber band. If two bracing structures are used, moving bracing structures 28 will give the user variable support when suspended in mid-air. The closer bracing structures 28 are to wheel assembly 11, the more support they give the user when he is suspended. Conversely, the farther bracing structures 28 are from wheel assembly 11, the less support they give.

Two grip portions 26 are integrally formed on harness structure 25. Hand brakes 27 are attached near each of grip portions 26, such that a user can easily actuate hand brakes 27 without his hand leaving grip portions 26. Hand brakes 27 are typically of the type most often found on bicycles. Each brake assembly 13 is connected to a corresponding hand brake 27 by way of a cable (not shown). Actuation of either hand brake 27 will engage the corresponding braking assembly 13, and bring that corresponding wheel 12 to a stop. In the preferred embodiment shown in FIG. 2, the left hand brake 27 will correspond to the left braking means 13, while the right hand brake 27 will correspond to the right braking means 13. In this way, when the user is suspended, actuation of only the right hand brake 27 will turn exercise machine 10 to the right, while actuation of only the left hand brake 27 will turn exercise machine 10 to the left as shown in FIG. 2.

In operation, machine 10 begins at rest, with landing assembly 32 on the ground. The user pushes down on harness structure 25, raising trailing end 30 into the air. If one bracing structure 28 is used, the user stands between bracing structure 28 and wheel assembly 11. If two bracing structures 28 are used, the user stands between bracing structures 28. The user then places his hands on grip portions 26, rests his forearms on bent portion 43, and begins running or walking, pulling machine 10. At any time, the user jumps, and is lifted off the ground by leading end 20. The user is supported by bracing structure 28. If two bracing structures 28 are used, he is supported by the bracing structure furthest from wheel assembly 11. While suspended, if the user wishes to turn the machine, he can actuate either, but not both, of hand brakes 27, which will engage corresponding braking assembly 13. That will in turn slow corresponding wheel 12 with respect to the non-braking wheel 12, thus making machine 10 turn. When the user wishes to return to the ground, he either leans forward in harness structure 25, or actuates both hand brakes 27.

1) A mobile exercise machine comprising:
a frame, said frame comprising a leading end portion and a trailing end portion;
a wheel assembly attached to and supporting said frame, said frame being movable on and rotatable relative to said wheel assembly;
a landing assembly attached to said trailing end portion;
a harness structure attached to said frame at said leading end portion;
said trailing end portion designed to carry a weight proportionate to the weight of the user.

2) The mobile exercise machine as described in claim 1, wherein said harness structure is able to accommodate the body of a user.

3) The mobile exercise machine as described in claim 1, wherein the leading end portion may be rotated about the wheel assembly relative to the trailing end portion.

4) The mobile exercise machine as described in claim 1, wherein the frame further comprises a tying structure connecting the leading end portion and the trailing end portion.

5) The mobile exercise machine as described in claim 4, wherein the tying structure has a first end and a second end, said first end being connected to the leading end portion of the frame at a connection point and said tying structure being rotatable about that connection point.

6) The mobile exercise machine as described in claim 4, wherein the trailing end portion includes a plurality of affixation points to allow connection of the second end to the trailing end portion at various ones of said affixation points whereby distance between the leading end portion and the trailing end portion may be varied as desired.

7) The mobile exercise machine as described in claim 1, wherein the wheel assembly comprises two wheels, each wheel being able to rotate independently of the other.

8) The mobile exercise machine as described in claim 7, wherein each wheel is attached to a braking means operable by the user.

9) The mobile exercise machine as described in claim 1, wherein the harness structure comprises two grip portions, said grip portions being arranged to accommodate a typical user's hands.

10) The mobile exercise machine as described in claim 9, wherein two hand brakes are attached to the grip portions.

11) The mobile exercise machine as described in claim 1, wherein the landing assembly comprises a set of wheels.

12) A mobile exercise machine comprising:
a wheel assembly comprising two wheels, each wheel being able to rotate independently from the other;
a braking means attached to each wheel of said wheel assembly;
a frame, said frame being mounted on said wheel assembly and being movable on said wheel assembly, said frame comprising a leading end portion, a trailing end portion and a tying structure attached to the leading end portion and the trailing end portion, said leading end portion being able to rotate about said wheel assembly relative to said trailing end portion;
a landing assembly attached to said trailing end portion, said landing assembly comprising a set of wheels, said wheels being generally able to rotate about the point at which said set is attached to the trailing end portion;
a harness structure attached to said frame at said leading end portion, said harness structure being able to accommodate the body of a user and including grip portions to accommodate an average user's hands;
a hand brake attached to each of said grip portions;
said trailing end portion designed to carry a weight proportionate to the weight of the user.

13) The mobile exercise machine of claim 11, wherein each hand brake is attached to a corresponding braking means such that actuation of the hand brake will engage said braking means.

14) The mobile exercise machine of claim 11, wherein the harness structure further comprises two bracing structures, said bracing structures being generally moveable about the harness structure to provide the desired support for the user.

15) The mobile exercise machine of claim 11, wherein the landing assembly is generally biased in one direction.

16) A mobile exercise machine comprising:
a wheel assembly comprising two wheels, each wheel being able to rotate independently from the other;
a braking mechanism attached to each wheel of said wheel assembly;
a frame, said frame attached to and supported by said wheel assembly and being movable on said wheel assembly, said frame comprising a leading end portion, a trailing end portion and a tying structure attached to the leading end portion and the trailing end portion, said leading end portion being able to rotate about said wheel assembly relative to said trailing end portion;
a landing assembly attached to said trailing end portion, said landing assembly comprising a set of wheels, said set being generally able to rotate about the point at which it is attached to the trailing end portion, but being generally biased in one direction;
a harness structure attached to said frame at said leading end portion, said harness structure being able to accommodate the body of a user and including grip portions to accommodate a user's hands and at least two bracing structures, said bracing structures being attached to but generally moveable relative to the harness structure to provide the desired support for the user;
a hand brake attached to each of said grip portions, each hand brake attached to a corresponding braking means such that actuation of the hand brake will operate the braking means;
said trailing end portion designed to carry a weight proportionate to the weight of the user.
